(19) United States
(12) Patent Application Publication
(10) Pub. No.: US 2006/0249117 A1
(43) Pub. Date: Nov. 9, 2006

(54) GLOW-IN-THE-DARK USER INTERFACES FOR SMALL INTERNAL COMBUSTION ENGINES

(75) Inventor: Steven T. Davis, Green Bay, WI (US)

Correspondence Address: BAKER & DANIELS LLP;111 E. WAYNE STREET, SUITE 800, FORT WAYNE, IN, 46802, US

(73) Assignee: Tecumseh Products Company, Tecumseh, MI (US)

(21) Appl. No.: 11/380,968

(22) Filed: May 1, 2006

Related U.S. Application Data
(60) Provisional application No. 60/679,200, filed on May 9, 2005.

(51) Int. Cl. F02M 17/40

(52) U.S. Cl. 123/198 D; 261/35; 261/DIG. 8

(57) ABSTRACT

A small internal combustion engine having user interfaces which are formed at least in part of at least one glow-in-the-dark or luminescent material. The user interfaces may include, for example, the carburetor choke and throttle controls, the carburetor primer bulb, the carburetor primer bulb base, the engine ignition key switch, the ignition key, the fuel shut-off valve member, the recoil starter handle, the fuel tank cap, and the oil fill cap.

### CROSS-REFERENCE TO RELATED APPLICATIONS

The present application clams the benefit under Title 35, U.S.C. § 119(e) of U.S. Provisional Patent Application Ser. No. 60/679,200, entitled GLOW-IN-THE-DARK USER INTERFACES FOR SMALL INTERNAL COMBUSTION ENGINES, filed on May 9, 2005, the disclosure of which is expressly incorporated by reference herein.

### BACKGROUND

1. Field of the Invention

The present invention relates to small internal combustion engines of the type typically used with lawnmowers, lawn and garden tractors, small sport vehicles, generators, snow-throwers, or other small working implements, and, more particularly, the present invention relates to user interfaces of such small internal combustion engines.

2. Description of the Prior Art

Small internal combustion engines typically include a number of user interfaces which are manipulated by a user of the engine in order to operate, maintain, and service the engine. These user interfaces include engine controls for starting, stopping, and varying the speed of the engine. For example, in engines with carburetors, a choke control is actuated to provide an enriched air/fuel mixture to the engine to aid in starting, and a throttle control is used to regulate the amount of air/fuel mixture delivered to the engine in order to vary the engine speed. Other engine controls include ignition switches for enabling or disabling engine ignition, as well as fuel shut-off valve members for opening and closing the flow of fuel from the fuel tank of the engine to the carburetor.

In addition to the engine controls, other user interfaces for small internal combustion engines include the fuel tank cap, which is removed from the fuel tank for filling fuel into the fuel tank, as well as the oil fill cap, which is removed from the oil fill conduit for filling oil into the crankcase of the engine.

The foregoing user interfaces must be accessed by a user, some more frequently than others, for operating, maintaining, and servicing the engine. However, a problem with known small engines is that these interfaces are occasionally used in an environment with little or no light. Consequently, the user interfaces are difficult to locate and operate in such a dark environment. For example, a generator may need to be used when a power outage occurs, or a snow-thrower may need to be operated at night, for example. The typical user interfaces on a conventional generator require the use of an external light source to locate and identify the user interfaces.

### SUMMARY

The present invention provides a small internal combustion engine having user interfaces which are formed at least in part of at least one glow-in-the-dark or luminescent material. The user interfaces may include, for example, the carburetor choke and throttle controls, the carburetor primer bulb, the carburetor primer bulb base, the engine ignition key switch, the ignition key, the fuel shut-off valve member, the recoil starter handle, the fuel tank cap, and the oil fill cap.

Advantageously, forming user interfaces of the engine at least in part of a glow-in-the-dark or luminescent material allows the user interfaces to be easily identified and/or located by a user when the implement with which the engine is used is operated in a reduced light environment, such as during the night.

In one form thereof, the present invention provides an internal combustion engine, including at least one user interface, the at least one user interface formed at least in part of at least one luminescent material.

In another form thereof, the present invention provides an internal combustion engine, including at least one user interface including a rigid body portion formed at least in part of at least one luminescent material.

In another form thereof, the present invention provides an internal combustion engine, including at least one user interface including a resilient body portion formed at least in part of at least one luminescent material.

### BRIEF DESCRIPTION OF THE DRAWINGS

The above mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a front perspective view of an engine, including several user interfaces;

FIG. 2 is a fragmentary perspective view of the oil fill cap of the engine of FIG. 1;

FIG. 3 is a fragmentary perspective view of the fuel tank cap of the engine of FIG. 1;

FIG. 4 is a fragmentary perspective view of the fuel shut-off valve member of the engine of FIG. 1;

FIG. 5 is a fragmentary perspective view of the recoil starter handle of the engine of FIG. 1;

FIG. 6 is a fragmentary perspective view of the carburetor primer bulb and associated base of the engine of FIG. 1;

FIG. 7 is a fragmentary perspective view of the carburetor throttle control knob of the engine of FIG. 1;

FIG. 8 is a fragmentary perspective view of the carburetor choke control knob of the engine of FIG. 1;

FIG. 9 is a fragmentary perspective view of the ignition key switch and ignition key of the engine of FIG. 1; and

FIG. 10 is a chart showing decreasing luminance over time for an exemplary luminescent material according to two charging scenarios.

Corresponding reference characters indicate corresponding parts throughout the several views. The exemplifications set out herein illustrate preferred embodiments of the invention, and such exemplifications are not to be construed as limiting the scope of the invention in any manner.

### DETAILED DESCRIPTION

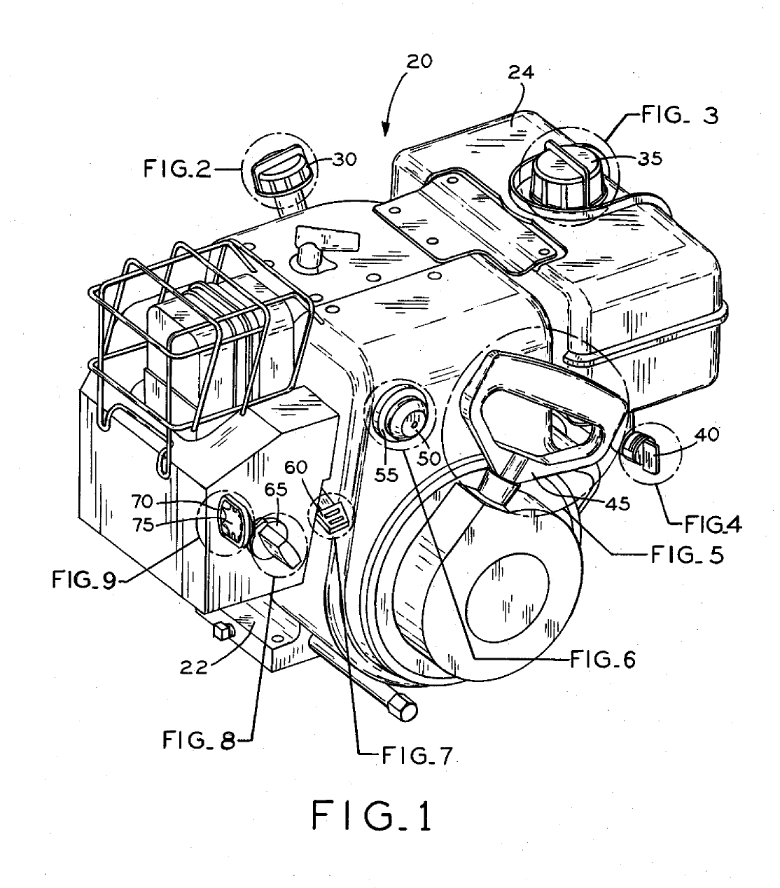

Referring to FIG. 1, a small internal combustion engine 20 is shown, which is similar to those described in detail in U.S. Pat. No. 6,941,914, entitled INTERNAL COMBUSTION ENGINE, issued on Sep. 13, 2005, and U.S. Pat. No. 6,857,410, entitled ENGINE CONTROL SYSTEM, issued on Feb. 22, 2005, both assigned to the assignee of the present invention, the disclosures of which are expressly incorporated herein by reference. Engine 20 generally includes crankcase 22, fuel tank 24, and a number of user interfaces as described below. Engine 20 may be a single or two-cylinder engine, and may have a horizontally or vertically oriented crankshaft. Engine 20 may be used with implements (not shown), such as a lawnmowers, lawn and garden tractors, small sport vehicles, generators, snow-throwers, or other small working implements.

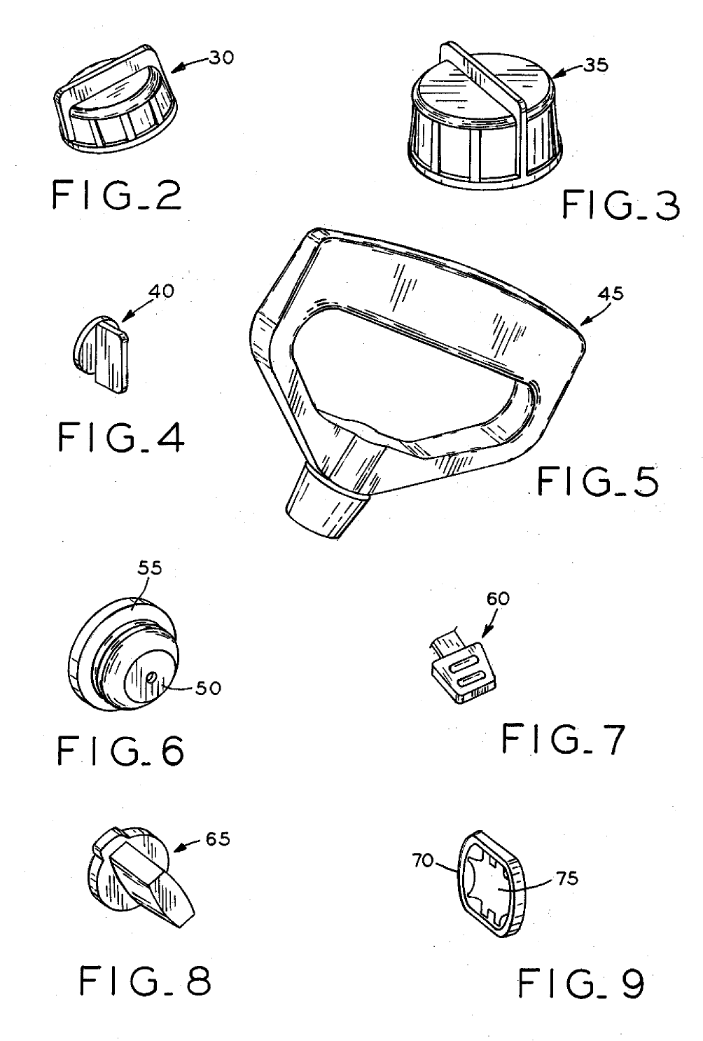

As used herein, the term “user interface” refers to an engine component which is operated by a user in the normal course of operating, maintaining, or servicing an internal combustion engine such as engine 20, including, for example, the carburetor choke and throttle controls, carburetor primer bulb, carburetor primer bulb base, ignition key switch, ignition key, fuel shut-off valve member, recoil starter handle, fuel tank cap, and oil fill cap of the engine. Specifically, as shown in FIG. 1, engine 20 includes oil fill cap 30 (FIG. 2), fuel tank cap 35 (FIG. 3), fuel shut-off valve member 40 (FIG. 4), recoil starter handle 45 (FIG. 5), carburetor primer bulb 50 and base 55 (FIG. 6), carburetor throttle control knob 60 (FIG. 7), carburetor choke control knob 65 (FIG. 8), ignition key switch 70 (FIG. 9), and ignition key 75 (FIG. 9).

One or more of oil fill cap 30, fuel tank cap 35, fuel shut-off valve member 40, recoil starter handle 45, carburetor primer bulb base 55, carburetor throttle control knob 60, carburetor choke control knob 65, ignition key switch 70, and ignition key 75 may be formed at least in part of a body portion of a rigid plastic having glow-in-the-dark, or luminescent, properties. Typically, the human eye can detect a visible glow greater than approximately 0.3 milicandelas per square meter (mcd/m²).

Suitable glow-in-the-dark or luminescent materials include “Long Glow Olefin” and “NY Zytel ST801” manufactured by Clariant Masterbatches of Minneapolis, Minn. which may be supplied in the form of pellets, for example. Alternatively, other suitable materials may include the following: RTP 100, 300, 600, 1200, and 2800 Series GITD Polypropylene Compounds, manufactured by RTP Company of Winona, Minn., as well as other materials containing phosphorescent pigments which absorb ultraviolet light and slowly emit energy over time; compounds including fluorescent day glow pigments or photoluminescent pigments; and “Strontium Aluminate,” manufactured by GloTech International of Auckland, New Zealand.

Particular exemplary user interfaces may be molded from high density polyethylene (“HDPE”, available from many commercial sources) along with a luminescent additive (Part No. PEA0642491, available from Clariant Corporation, Minneapolis, Minn.) at a ratio of HDPE to additive of 20:1 (See Example 2 below), or may be molded from a nylon such as Zytel® ST801 along with a luminescent additive (Part No. ABA0642427, available from Clariant Corporation, Minneapolis, Minn.) at a ratio of nylon to additive of 13:1 (Zytel® is a registered trademark of E.I. du Pont de Nemours and Company). The foregoing ratios may vary, for example, may be as high as 5:1 or 10:1, or as low as 25:1 or 30:1.

The glow or luminescence of these materials may last up to 8-12 hours after exposure to light, and the material may have sufficient longevity and be able to function in extreme temperatures, for example, below 0° F. The rigid plastic user interfaces may be formed via an injection molding process with the above-listed plastics. Alternatively, the rigid plastic user interfaces may be formed of injection molded plastics with glow-in-the-dark additives mixed into existing plastics before or during the injection molding process.

Carburetor primer bulb 50 is made at least in part of a body portion of a resilient or flexible material such as rubber, for example, which has glow-in-the-dark or luminescent properties. For example, carburetor primer bulb 50 may be formed of ethylene propylene, commonly known as EPT, EPR or EPDM, manufactured by Equistar Chemicals, LP of Houston, Tex.

In one embodiment, such as use of engine 20 in a snow thrower, for example, the luminescent material used for at least one engine interface could have a charge time of between 1-3 minutes by natural or artificial light, and would thereafter glow for at least one hour. In other applications, such as use of engine 20 in a generator, the luminescent material may require a longer charge time in order to produce a glow for greater than one hour.

### EXAMPLE 1

One exemplary glow-in-the-dark or luminescent material is a thermoplastic, such as polypropylene or polyethylene, having a luminescent pigment additive, for example, Series 100 materials available from RTP Company of Winona, Minn. (www.rtpcompany.com). Two 0.120 inch (3.0 mm polypropylene samples were charged, i.e., exposed to a source of light, namely, a xenon arc lamp, at 54 lux for 60 minutes and at 1000 lux for 10 minutes, respectively, at a temperature of 73° F. (23° C.). In Table 1 below, the luminance is set forth in mCd/m² with respect to the two foregoing samples after the indicated elapsed times.

TABLE 1

| | 54 lux, 60 minutes | 1000 lux, 10 minutes |
|---|---|---|
| Time (minutes) | Luminance (mCd/m²) | Luminance (mCd/m²) |
| 0 | 1640 | 2610 |
| 1 | 563 | 929 |
| 5 | 147 | 303 |
| 15 | 87.7 | 152 |
| 30 | 63.4 | 101 |
| 45 | 21.7 | 29.8 |
| 60 | 16.0 | 21.3 |
| 90 | 10.1 | 12.9 |
| 120 | 7.25 | 9.2 |
| 150 | 5.52 | 6.93 |
| 180 | 4.55 | 5.63 |
| 240 | 3.25 | 4.01 |
| 300 | 2.38 | 3.25 |

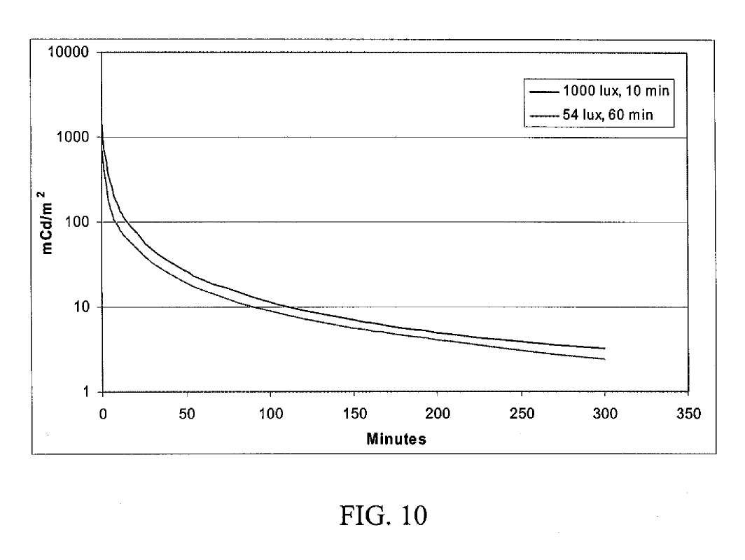

The above data is also shown in FIG. 10, wherein the elapsed time to reach a luminance of 0.3 mCd/m² for the 1000 lux/10 minute sample was about 570 minutes, and the elapsed time to reach a luminance of 0.3 mCd/m² for the 54 lux/60 minute sample was about 457 minutes.

### EXAMPLE 2

The following qualitative test was used to determine the duration of visible active light emitted from user interface components produced from luminescent materials after a specific length of exposure to a known light source. Throttle control knobs 60 (FIG. 7) and choke control knobs 65 (FIG. 8) were molded from high density polyethylene (“HDPE”, available from many commercial sources) along with a luminescent additive (Part No. PEA0642491, available from Clariant Corporation, Minneapolis, Minn.) at a ratio of HDPE to additive of 20:1.

As described below, the present test was designed to replicate typical conditions in which an implement including internal combustion engine 20 having luminescent user interfaces would likely be used. The throttle and choke control knobs were placed inside a light-sealed container for 1-week at room temperature prior to the test and, at the time of the test, the light-sealed container was placed inside a darkened chamber and held at 0° F. for 4 hours to cool the knobs and thereby replicate engine storage during winter in a darkened space such as a garage or shed, for example. Inside of the darkened chamber, one each of the throttle and choke control knobs were removed from the sealed container and placed 6 feet from an incandescent light source in the form of a 100-watt incandescent light bulb. The first knobs were exposed to the lit bulb for 3 minutes. After 2 minutes had elapsed, a second one each of the throttle and choke control knobs were removed from the sealed container and placed 6 feet from the bulb, and were exposed to the lit bulb for 1 minute, such that the first knobs were each exposed for three minutes and the second knobs were each exposed for one minute. The foregoing replicates use of an implement at night when the implement is first exposed to incandescent light for a limited amount of time in a garage, for example, and then is taken out of the garage for use in the dark. After three minutes, the light bulb was turned off so the glow of the knobs in the darkened chamber could be monitored visually.

The person performing the test allowed a minimum of 3 minutes for vision adjustment to the dark environment before visual readings were taken. Readings were taken every 10 minutes. The test duration was 60 minutes. During the final 15 minutes of test, the person performing the test remained in the darkened chamber for the final readings. The results are summarized in Table 2 below as follows:

TABLE 2

| | Light exposure | Duration of glow following |
|---|---|---|
| Component | time (min.) | light exposure time |
| Throttle control knob 1 | 1 | Luminescence readily |
| | | visible up to 50 min. |
| Throttle control knob 2 | 3 | Luminescence readily |
| | | visible for over 60 min. |
| Choke control knob 1 | 1 | Luminescence readily |
| | | visible up to 50 min. |
| Choke control knob 2 | 3 | Luminescence readily |
| | | visible for over 60 min. |

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An internal combustion engine, comprising:
at least one user interface, said at least one user interface formed at least in part of at least one luminescent material.

2. The internal combustion engine of claim 1, wherein said at least one user interface comprises a rigid body.

3. The internal combustion engine of claim 2, wherein said rigid body comprises an oil fill cap.

4. The internal combustion engine of claim 2, wherein said rigid body comprises a fuel tank cap.

5. The internal combustion engine of claim 2, wherein said rigid body comprises a fuel shut-off valve member.

6. The internal combustion engine of claim 2, wherein said rigid body comprises a recoil starter handle.

7. The internal combustion engine of claim 2, wherein said rigid body comprises a carburetor primer bulb base.

8. The internal combustion engine of claim 2, wherein said rigid body comprises a carburetor throttle control knob.

9. The internal combustion engine of claim 2, wherein said rigid body comprises a carburetor choke control knob.

10. The internal combustion engine of claim 2, wherein said rigid body comprises an ignition key switch.

11. The internal combustion engine of claim 2, wherein said rigid body comprises an ignition key.

12. The internal combustion engine of claim 1, wherein said at least one user interface comprises a resilient body.

13. The internal combustion engine of claim 12, wherein said resilient body comprises a carburetor primer bulb.

14. The internal combustion engine of claim 1, wherein said luminescent material has a visible glow greater than approximately 0.3 milicandelas per square meter (mcd/m²).

15. An internal combustion engine, comprising:
at least one user interface including a rigid body portion formed at least in part of at least one luminescent material.

16. The internal combustion engine of claim 15, wherein said user interface is selected from the group consisting of an oil fill cap, a fuel tank cap, a fuel shut-off valve member, a recoil starter handle, a carburetor primer bulb base, a carburetor throttle control knob, a carburetor choke control knob, an ignition key switch, and an ignition key.

17. The internal combustion engine of claim 15, wherein said luminescent material has a visible glow greater than approximately 0.3 milicandelas per square meter (mcd/m²).

18. An internal combustion engine, comprising:
at least one user interface including a resilient body portion formed at least in part of at least one luminescent material.

19. The internal combustion engine of claim 18, wherein said user interface comprises a carburetor primer bulb.

20. The internal combustion engine of claim 18, wherein said luminescent material has a visible glow greater than approximately 0.3 milicandelas per square meter (mcd/m²).
